(19) United States
(12) Patent Application Publication
(10) Pub. No.: US 2008/0170782 A1
(43) Pub. Date: Jul. 17, 2008

(54) Image processing apparatus, information management system, process for processing image, computer readable medium and computer data signal

(75) Inventor: Mariko Ogi, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/802,894

(22) Filed: May 25, 2007

(30) Foreign Application Priority Data
Dec. 28, 2006 (JP) 2006-355463

(51) Int. Cl. G06K 9/34

(52) U.S. Cl. 382/173

(57) ABSTRACT

An image processing apparatus includes: an image reading unit that reads an information image on which a plurality of sets each of which comprises image information and additional information are displayed according to a predetermined rule; an image information acquiring unit; an additional information acquiring unit; a positional relationship acquiring unit; a first partition setting unit that sets at least one first partition so as to divide a line of the plurality of sets in a first direction; a second partition setting unit that sets at least one second partition so as to divide a line of the plurality of sets in a second direction, wherein the first direction and the second direction are set to intersect with each other, and all the plurality of sets are individually placed in each area identified by the at least one first and second partitions; and a display control unit.

### CROSS-REFERENCE TO RELATED APPLICATION

This application is based on and claims priority under 35 USC 119 from Japanese Patent Application No. 2006-355463 filed Dec. 28, 2006.

### BACKGROUND

1. Technical Field

The present invention relates to an image processing apparatus, an information management system, a process for processing an image, a computer readable medium and a computer data signal.

2. Related Art

In recent years, a system has been proposed in which an information image having a plurality of pieces of information is read, and desired detailed information is obtained based on, for example, reference information included therein.

### SUMMARY

According to an aspect of the invention, there is provided an image processing apparatus including: an image reading unit that reads an information image on which a plurality of sets each of which comprises image information and additional information related to the image information are displayed according to a predetermined rule; an image information acquiring unit that acquires the image information from the information image read by the image reading unit; an additional information acquiring unit that acquires the additional information from the information image read by the image reading unit; a positional relationship acquiring unit that acquires a positional relationship between the image information and the additional information; a first partition setting unit that sets at least one first partition on the information image so as to divide a line of the plurality of sets in a first direction of the information image with respect to a display of the information image, based on the positional relationship acquired by the positional relationship acquiring unit; a second partition setting unit that sets at least one second partition on the information image so as to divide a line of the plurality of sets in a second direction of the information image with respect to a display of the information image, based on the positional relationship acquired by the positional relationship acquiring unit, wherein the first direction and the second direction are set to intersect with each other, and the at least one first partition and the at least one second partition are set so that all the plurality of sets are individually placed in each area identified by the at least one first partition and the at least one second partition; and a display control unit that displays an input screen that accepts instruction information for each area identified by the at least one first partition and the at least one second partition.

### BRIEF DESCRIPTION OF THE DRAWINGS

Exemplary embodiments of the present invention will be described in detail based on the following figures, wherein:

FIG. 1A and FIG. 1B show a structure of an information management system according to an exemplary embodiment of the present invention;

FIG. 2 shows a structure of an information management system including an image processing apparatus according to an exemplary embodiment of the present invention;

FIG. 3 shows an exemplary example of an information image;

FIG. 4 shows an exemplary example of vertical and horizontal partitions set in the information image;

FIG. 5A and FIG. 5B show another exemplary example of the information image and another exemplary example of vertical and horizontal partitions based on this information image, respectively;

FIG. 6A and FIG. 6B show still another exemplary example of the information image and still another exemplary example of vertical and horizontal partitions based on this information image, respectively;

FIG. 7 is a flowchart of the operation of the image processing apparatus according to an aspect of the present invention;

FIG. 8 is a flowchart of the operation of a server according to an aspect of the present invention; and

FIG. 9 shows a result of a replying process of detailed information.

### DETAILED DESCRIPTION

An exemplary embodiment for carrying out the present invention will be described with reference to the attached drawings.

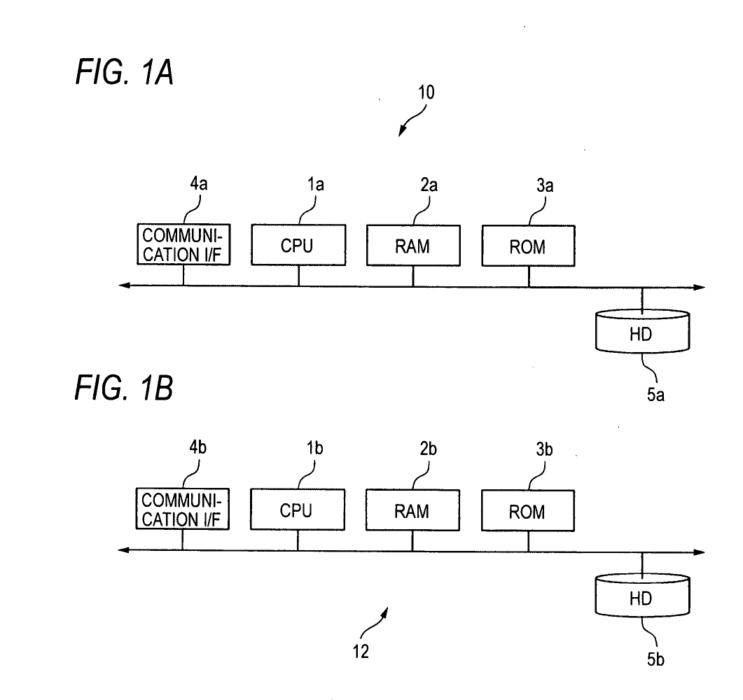

FIG. 1A and FIG. 1B show structural examples of an embodiment of an information management system according to an aspect of the present invention. FIG. 1A shows a structural example of an image processing apparatus 10 that is a constituent element of the information management system, and FIG. 1B shows a structural example of a server 12.

In FIG. 1A, the image processing apparatus 10 includes a CPU 1a, a random-access memory (RAM) 2a, a read-only memory (ROM) 3a, a communication interface 4a, and a hard disk drive (HD) 5a.

Based on a control program stored in the RAM 2a or the ROM 3a, the CPU 1a controls the operation of each section described later. The RAM 2a functions chiefly as a work area of the CPU 1a. The control program and other data used for the CPU 1a are stored in the ROM 3a.

The communication interface 4a is an appropriate communication interface, such as a USB (Universal Serial Bus) port or a network port, and is used to allow the CPU 1a to have an information communication with the server 12.

The hard disk drive 5a is a high-capacity storage device, and is capable of storing all pieces of data needed for steps described later.

On the other hand, as shown in FIG. 1B, the server 12 includes a CPU 1b, a RAM 2b, a ROM 3b, a communication interface 4b, and a hard disk drive 5b.

The CPU 1b, the RAM 2b, and the ROM 3b function in the same way as the CPU 1a, the RAM 2a, the ROM 3a, and the hard disk drive 5a of the image processing apparatus 10, and hence a description of these elements is omitted.

The communication interface 4b is an appropriate communication interface, such as a USB (Universal Serial Bus) port or a network port, and is used to allow the CPU 1b to have an information communication with the image processing apparatus 10.

The hard disk drive 5b is a high-capacity storage device, and is capable of storing all pieces of data needed for steps described later. Especially, the hard disk drive 5b constructs a detailed-information database that stores detailed information related to image information acquired by the image processing apparatus 10.

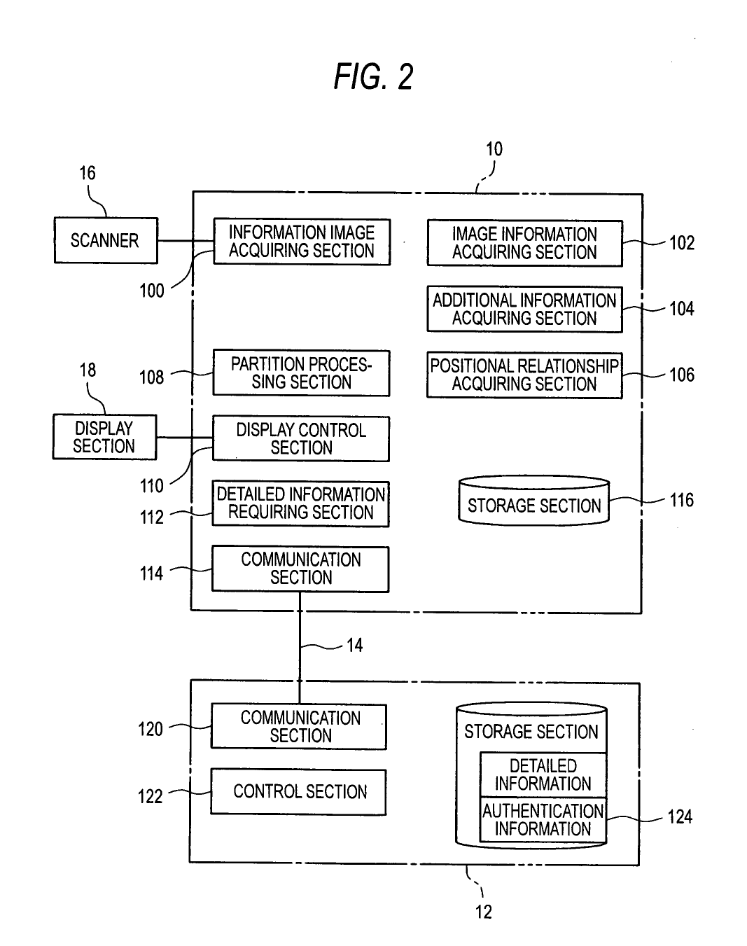

FIG. 2 shows a structural example of an embodiment of the information management system including the image processing apparatus 10 according to an aspect of the present invention. In FIG. 2, the information management system includes the image processing apparatus 10, the server 12, and a communication unit 14. The image processing apparatus 10 reads an information image on which a plurality of sets each of which contains image information and additional information related to this image information are displayed according to a predetermined rule, and requires the server 12 to send detailed information related to the image information through the communication unit 14. Here, as the predetermined rule, the arrangement in which a plurality of sets each of which contains image information and additional information related to this image information are displayed at even intervals in specific two directions is exemplified. The server 12 stores detailed information related to image information, and sends the detailed information, which is a reply to the demand of an authenticated user, through the communication unit 14. The communication unit 14 is a device used to send and receive network information and other information.

The image processing apparatus 10 includes an information image acquiring section 100, an image information acquiring section 102, an additional information acquiring section 104, a positional relationship acquiring section 106, a partition processing section 108, a display control section 110, a detailed information requiring section 112, a communication section 114, and a storage section 116.

The information image acquiring section 100 is realized by a central processing unit (CPU) and a program that controls the processing operation of the CPU, and obtains an information image read by a scanner 16 through an interface with the scanner 16. The information image is an image on which a plurality of sets each of which contains image information and additional information related to this image information are displayed according to a predetermined rule.

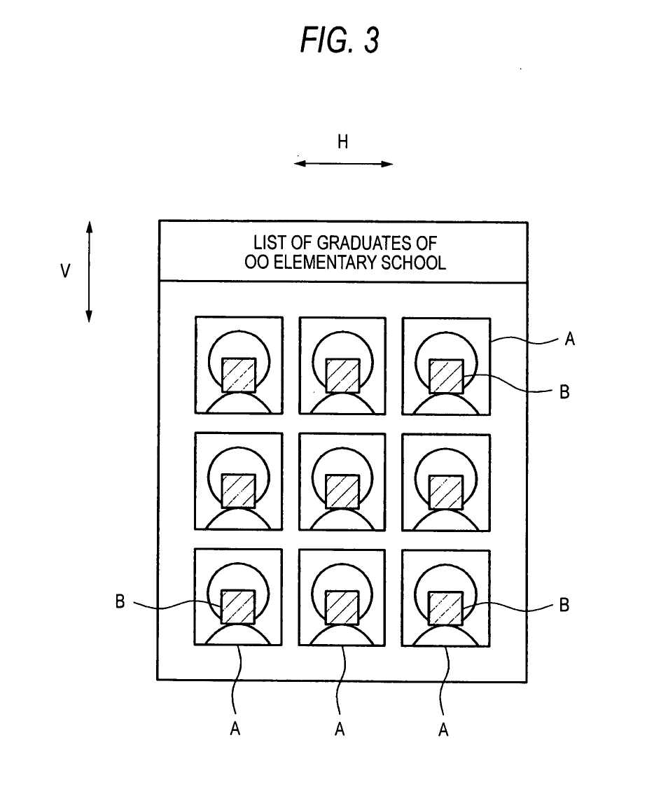

FIG. 3 shows an exemplary example of the information image. The information image of FIG. 3 is a list of graduates of an elementary school. In this list, a photograph A of each graduate that is a piece of image information and additional information B superimposed on the photograph A are combined together. The photographs A on each of which the additional information B is superimposed are arranged according to a predetermined rule so as to form an array of three rows and three columns with a predetermined interval therebetween vertically and horizontally. The number of sets of the photograph A and the additional information B is not limited to nine (9=3×3), and may be arbitrarily determined. The additional information B is formed as, for example, a two-dimensional code, and holds storage-location information that shows the storage location of detailed information related to the image information stored in the server 12.

The image information acquiring section 102 is realized by the CPU and a program that controls the processing operation of the CPU, and obtains image information from the information image obtained by the image reading section 100. In the exemplary example of FIG. 3, photographs A are obtained. The image information acquiring section 102 has a function to make a distinction between image information included in the information image and additional information. A method for making a distinction therebetween will be described later.

The additional information acquiring section 104 is realized by the CPU and a program that controls the processing operation of the CPU, and obtains additional information from the information image obtained by the image reading section 100. The additional information acquiring section 104 also has a function to make a distinction between image information and additional information.

The positional relationship acquiring section 106 is realized by the CPU and a program that controls the processing operation of the CPU, and obtains a positional relationship between image information obtained by the image information acquiring section 102 and additional information obtained by the additional information acquiring section 104. For example, this positional relationship is information showing the fact that image information and additional information are superimposed on each other, or the fact that additional information is placed under or beside image information. The positional relationship in the example of FIG. 3 is that the image information and the additional information are superimposed on each other.

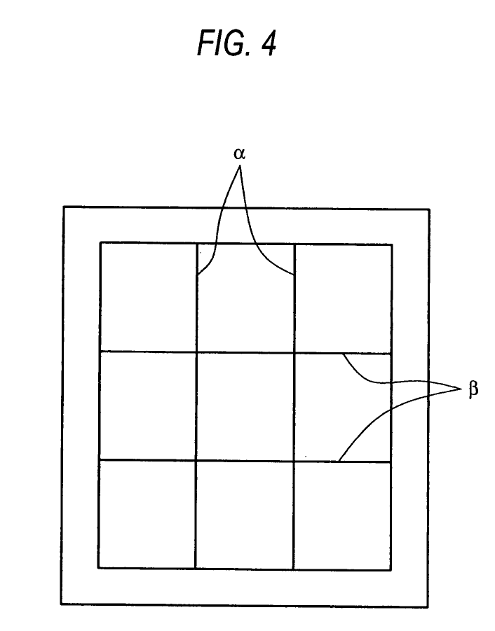

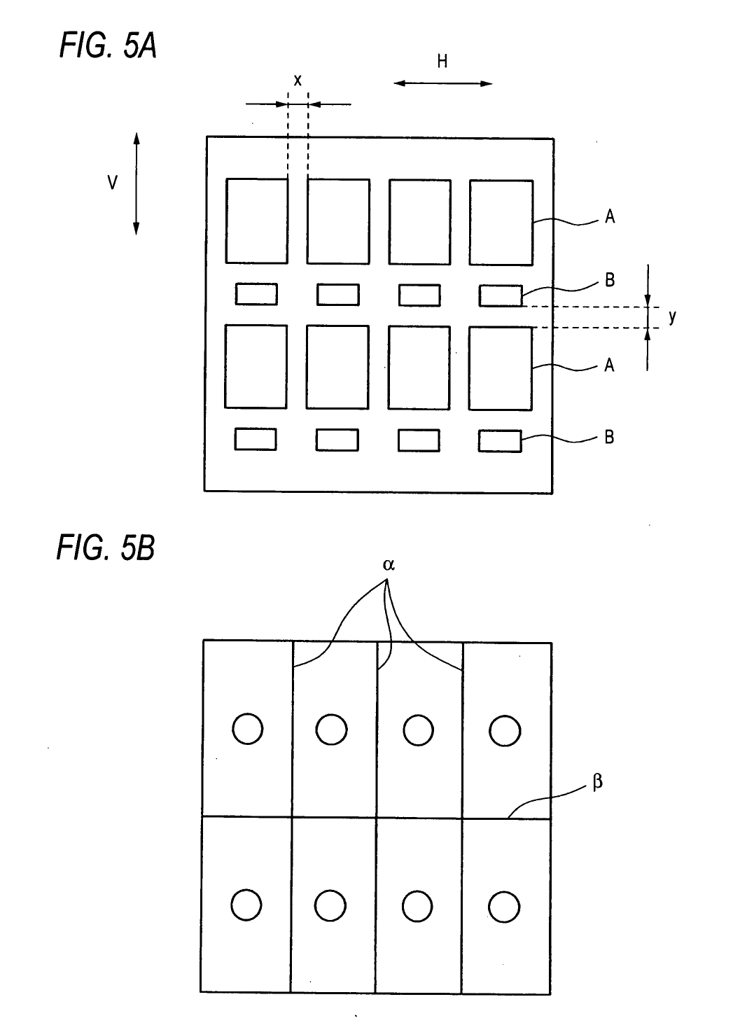

The partition processing section 108 is realized by the CPU and a program that controls the processing operation of the CPU. Based on the positional relationship obtained by the positional relationship acquiring section 106, the partition processing section 108 sets vertical partition by which a line in a rightward and leftward direction is divided and horizontal partition by which a line in an upward and downward direction is divided for each set of image information and additional information. The partition processing section 108 emits an error signal when all the pairs of the image information and the additional information are not individually placed in each area divided by the vertical partition and the horizontal partition, as a result of the setting of the vertical partition and the horizontal partition. The setting of the vertical partition and the horizontal partition will be described later with reference to FIG. 4, FIG. 5A, and FIG. 5B.

The display control section 110 is realized by the CPU and a program that controls the processing operation of the CPU, and displays an information image, vertical and horizontal partitions set for this information image, etc., on the display screen of a display section 18. In addition, an input screen that accepts instruction information is displayed on the display section 18 for each area divided by the vertical partition and the horizontal partition. This instruction information is an instruction given to, for example, obtain the detailed information mentioned above from a storage location set in the server 12. A detailed description of the input screen will be given later with reference to FIG. 5B.

The display section 18 includes a liquid crystal display (LCD) and a touch panel.

The detailed information requiring section 112 is realized by the CPU and a program that controls the processing operation of the CPU. Based on instruction information input from the input screen, the detailed information requiring section 112 requires the server 12 to send detailed information related to image information through the communication section 114.

The communication section 114 is realized by an appropriate communication interface, such as a USB (Universal Serial Bus) port or a network port, and communicates information with the server 12 through the communication unit 14.

The storage section 116 is realized by magnetic-storage devices, such as a random-access memory (RAM), a read-only memory (ROM), and a hard disk drive that are used as working memories of the CPU, and computer-readable storage devices other than the magnetic-storage devices. The storage section 116 stores a program that controls the processing operation of the CPU and information images acquired by the information image acquiring section 100.

The present invention has been applied to a nominal list in the exemplary embodiment described above with reference to FIG. 3. However, the present invention is not limited to the nominal list.

Additionally, for example, a part of the image processing system of FIG. 2 according to an aspect of the present invention may be formed of dedicated hardware (e.g., ASIC), and another part thereof may be disposed in an outer system and be connected via communication lines. Additionally, a plurality of such image processing systems may be connected together via communication lines and be operated in cooperation with each other. Additionally, the image processing system may be incorporated into a copying machine, a fax machine, a scanner, a printer, or a multifunction apparatus (which is also called a “multifunctional copying machine, having a scanner function, a printer function, a copy function, and a fax function).

FIG. 4 shows an exemplary example of vertical and horizontal partitions set for the information image of FIG. 3. Herein, the term “vertical” and the term “horizontal” denote a vertical direction (i.e., direction of arrow V) and a horizontal direction (i.e., direction of arrow H), respectively, in an information image shown as in FIG. 3. Hereinafter, an “upward and downward” direction denotes the vertical direction in the drawings, and a “rightward and leftward” direction denotes the horizontal direction in the drawings. The information image of FIG. 3 has a positional relationship in which image information and additional information B are superimposed on each other. Therefore, in FIG. 4, the partition processing section 108 calculates a distance between peripheries (i.e., sides of a rectangle) of adjoining pieces of image information, and a vertical partition line α and a horizontal partition line β are set at half the resulting distance, i.e., at the intermediate position between the peripheries. The vertical partition line α and the horizontal partition line β are examples of the vertical and horizontal partitions of the present invention. However, each of the vertical and horizontal partitions is not required to be displayed in the form of a line as in this embodiment, and may be designed to have a logical division for each set of image information and additional information B. Additionally, what is required of the partition processing section 108 is to divide adjoining pieces of image information, without being limited to the setting at the intermediate position between peripheries (sides of a rectangle) of the adjoining pieces of image information.

FIG. 5A and FIG. 5B show another exemplary example of the information image and another exemplary example of the vertical and horizontal partitions based on the information image, respectively. In FIG. 5A, each information image contains a photograph A serving as image information and additional information B. This example has a positional relationship in which the additional information B is disposed under the photograph A. Accordingly, with respect to the rightward and leftward direction of the information image, the partition processing section 108 bisects a distance x between peripheries (sides) of photographs A that laterally adjoin each other and that face each other, and sets a vertical partition line α at the intermediate position between the two sides. On the other hand, with respect to the upward and downward direction of the information image, the partition processing section 108 extracts additional information B of the upper-side information image and a photograph A of the lower-side information image, then bisects a distance y between the lower periphery of the additional information B and the upper periphery of the photograph A, and sets a horizontal partition line β at the intermediate position between the two peripheries. FIG. 5B shows an exemplary example of the vertical and horizontal partition lines α and β set in this way. Note that a vertical partition line α and a horizontal partition line β may be set in the same way as above even if the additional information B is disposed over the photograph A.

If the number in horizontal and vertical directions of sets each of which contains a photograph A and additional information B is known beforehand, the position of a vertical partition line α and the position of a horizontal partition line α may be set by detecting a distance between both ends in the rightward and leftward direction of an information image and a distance between both ends in the upward and downward direction of the information image and by dividing the distance therebetween by the number in horizontal and vertical directions of the sets for each rightward and leftward direction and each upward and downward direction.

Although the exemplary example of FIG. 5A has a positional relationship in which the additional information B is disposed under the photograph A, another positional relationship may be formed in which the additional information B is disposed beside the photograph A (i.e., is disposed on the right or left side of the photograph A). In this case, the distance x mentioned above corresponds to a distance between a right or left periphery of the photograph A and a periphery of the additional information B facing the right or left periphery of the photograph A, and the distance y mentioned above corresponds to a distance between peripheries (sides) of photographs A that adjoin in the upward and downward direction and that face each other.

FIG. 5B also shows an exemplary example of an input screen that accepts instruction information set for each area divided by the vertical partition line α and the horizontal partition line β. In FIG. 5B, a button shown by ∘ (open circle) is set on the screen in accordance with a set of the photograph A and the additional information B of FIG. 5A. A user determines a desired piece of detailed information according to the photograph of FIG. 5A, and operates a corresponding button, thus making it possible to input instruction information. For example, a method of making a determination with a pointing device, such as a mouse, or a method of pressing a touch panel displaying the image of FIG. 5B with fingers of the user may be mentioned as the button operating method.

The input screen is not limited to that of FIG. 5B, and various structures may be employed. For example, the position of a set of a photograph A and additional information B may be specified as an upper, lower, right, or left position from a predetermined reference point on the screen. Alternatively, a character, such as a numerical value, may be correlated with a set of a photograph A and additional information B, and be input. Alternatively, a string of letters corresponding to a photograph A may be displayed, and be selected. Alternatively, a photograph A may be displayed instead of a button. Instead of the input screen shown in FIG. 5B, a position-specifying pad may be used as a unit that inputs instruction information.

The server 12 shown in FIG. 2 includes a communication section 120, a control section 122, and a storage section 124.

The communication section 120 is realized by an appropriate communication interface, such as a USB (Universal Serial Bus) port or a network port, and communicates information with the image processing apparatus 10 through the communication unit 14.

The control section 122 is realized by the CPU and a program that controls the processing operation of the CPU. When a demand to send detailed information is made from the detailed information requiring section 112 of the image processing apparatus 10, the control section 122 performs a process for authenticating a user who has made this demand and a process for sending the detailed information.

The storage section 124 is realized by magnetic-storage devices, such as a random-access memory (RAM) and a hard disk drive that are used as working memories of the CPU, and computer-readable storage devices other than the magnetic-storage devices. The storage section 124 stores a program that controls the processing operation of the CPU, detailed information, authentication information, etc.

The detailed information is the one that is related to image information included in an information image, such as personal information (e.g., an individual address, name, or telephone number) or a detailed description of the contents of a product. The authentication information is information that is predetermined for each information image and that identifies a person having the qualifications to demand detailed information.

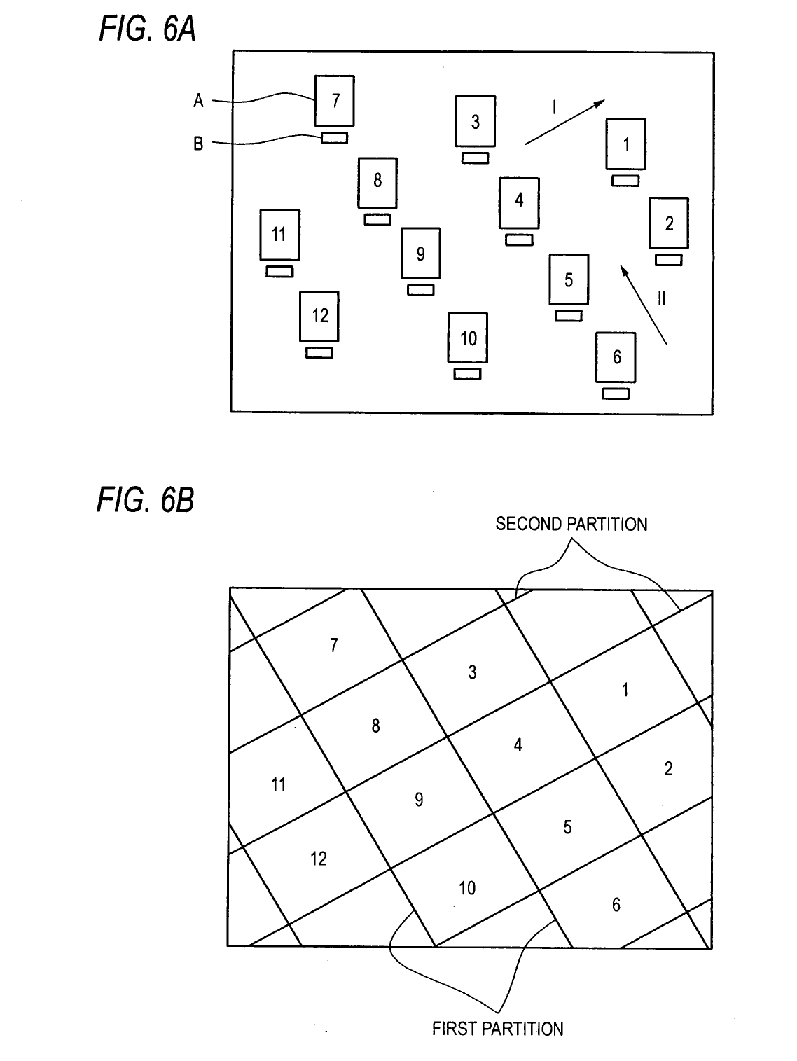

FIGS. 6A and 6B show still another exemplary example of the information image and still another exemplary example of the partitions based on this information image, respectively. The information image does not always have the structure of FIG. 5A in which photographs A serving as image information and pieces of additional information B are arranged in vertical and horizontal directions in the drawing. In the exemplary example of FIG. 6A, photographs A and pieces of additional information B are arranged in the oblique direction in the drawing. Hereinafter, the direction of arrow I is referred to as “first direction,” and the direction of arrow II is referred to as “second direction.” The terms “first” and “second” are given for convenience of explanation, and hence the embodiment is not limited to these.

In FIG. 6A, twelve pairs of photographs A, each of which is an element of an information image, and additional information B are arranged and numbered individually from 1 to 12. The partition processing section 108 obtains a positional relationship between the photographs A and the additional information B, and sets first partition that divides the line extending in the first direction and second partition that divides the line extending in the second direction. The first direction and the second direction are set to intersect with each other. Further, the first partition and the second partition are set so that each pair of a photograph A and a piece of additional information B is placed in each area divided by the first and second partitions.

FIG. 6B shows an exemplary example of the first and second partitions. A button, or the like, that accepts instruction information is set in an area divided by the first and second partitions in the same way as in FIG. 5B, thus forming an input screen. Numerals shown in FIG. 6B correspond to pair numbers of the pairs of the photographs A and the additional information B of FIG. 6A.

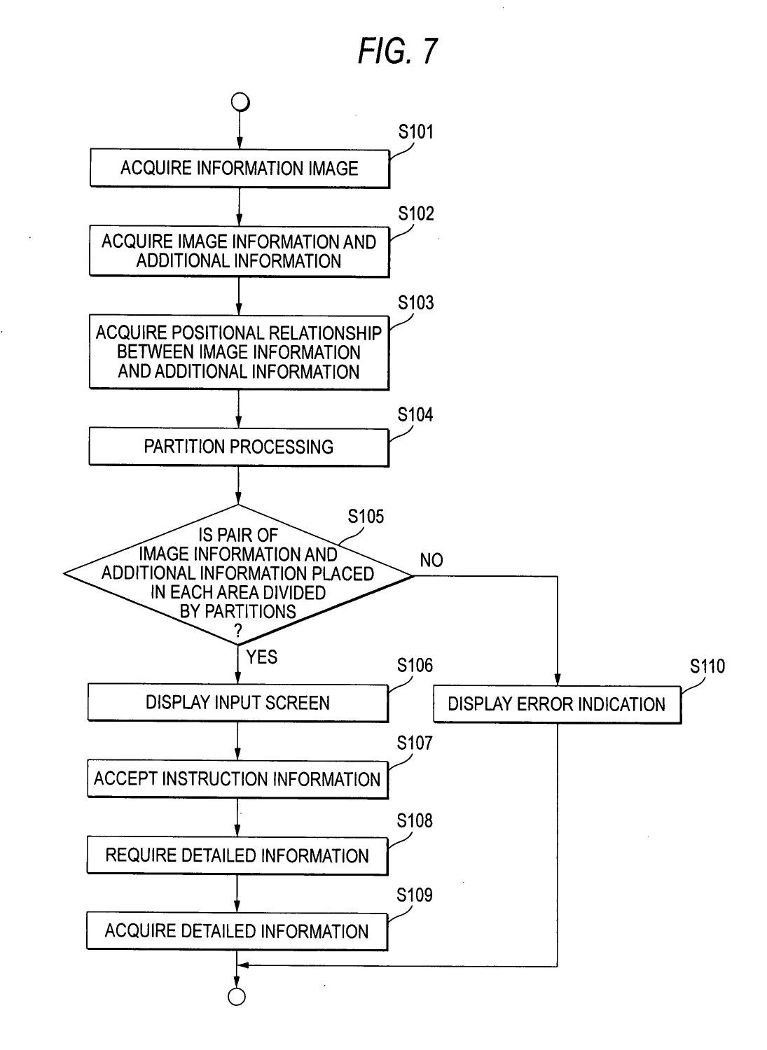

FIG. 7 shows the flow of the operation of the image processing apparatus 10 according to this embodiment. In FIG. 7, the scanner 16 reads an information image on which a plurality of sets each of which contains image information and additional information related to this image information are displayed according to a predetermined rule, and the information image acquiring section 100 acquires this information image (S101). It is permissible that only position coordinates of image information and additional information are acquired at step S101, and the contents of the image information and the additional information are analyzed when detailed information is demanded at step S108.

Thereafter, the image information acquiring section 102 acquires image information, such as photographic images, from the information image obtained by the image reading section 100. The additional information acquiring section 104 acquires additional information from the information image obtained by the image reading section 100 (S102).

Herein, a distinction between the image information and the additional information may be made through, for example, the following steps. First, edge components in vertical and horizontal directions are formed at predetermined positions of additional information. For example, if the additional information B having a rectangular shape is used, edge components in vertical and horizontal directions are formed at sides of the outer periphery of the rectangle or in the interior thereof. Thereafter, the edge components are detected from image data including the additional information by means of, for example, a differential filter. Thereafter, only the edge component of the additional information is extracted from these edge components by, for example, an autocorrelation, thus detecting the size of the image of the additional information. Thereafter, a cross-correlation is calculated by using an appropriate mask associated with the additional information, and the position of the additional information is specified from the maximum/minimum position of a correlation value, thus making it possible to make a distinction between the image information and the additional information. If the size of the image of the additional information is pre-known, there is no need to perform a step to determine the size of the image of the additional information. The process for making a distinction between the image information and the additional information is not limited to the steps mentioned above. For example, if the additional information is made up of two-dimensional bar codes and the like, a distinction method according to these may be employed.

Thereafter, the positional relationship acquiring section 106 acquires a positional relationship between image information acquired by the image information acquiring section 102 and additional information acquired by the additional information acquiring section 104 (S103).

Based on the positional relationship acquired by the positional relationship acquiring section 106, the partition processing section 108 performs a partition process for setting vertical and horizontal partitions to divide an information image in a rightward and leftward direction and in an upward and downward direction for each set of image information and additional information (S104). At this time, the partition processing section 108 confirms whether all the pairs of the image information and the additional information are individually placed in each area divided by the vertical and horizontal partitions (S105).

If all the pairs of the image information and the additional information are individually placed in each area at step S105, the display control section 110 displays the input screen shown in FIG. 5B on the display section 18 (S106).

Thereafter, a user inputs instruction information from the input screen. The detailed information requiring section 112 accepts this instruction information (S107), and requires the server 12 to send detailed information through the communication section 114 and the communication unit 14 (S108). When this detailed information is required to be sent, it may be preferable to add personal identification data (ID), or the like, which is used to authenticate the user who requires the server 12 to send the detailed information, to the requirement of the detailed information.

When the communication section 114 receives the detailed information that is a replay from the server 12, the display control section 110 allows the display section 18 to display the contents of the detailed information (S109).

If all the pairs of the image information and the additional information are not individually placed in each area at step S105, each area of the input screen shown in FIG. 5B may not be matched to a set of the image information and the additional information in a one-to-one ratio, and the display control section 110 allows the display section 18 to show an error indication (S110).

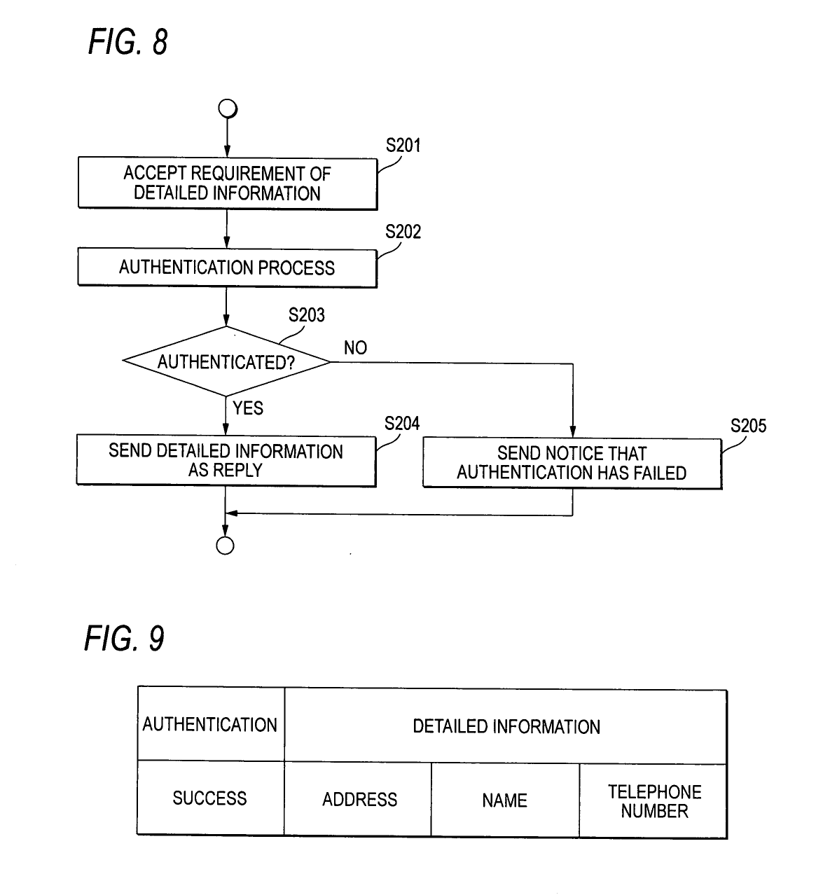

FIG. 8 shows the flow of the operation of the server 12 according to this embodiment. In FIG. 8, when the communication section 120 receives a demand to send detailed information from the detailed information requiring section 112 of the image processing apparatus 10 (S201), the control section 122 performs a user authentication process to authenticate the user who has required to send detailed information (S202). This authentication process is performed according to, for example, a method of making a comparison between a user ID sent together with the demand to send detailed information and a qualified person ID prestored in the storage section 124.

If the user is a qualified person as a result of the authentication process (S203), the control section 122 reads detailed information from the storage section 124, and sends this detailed information as a reply to the image processing apparatus 10 through the communication section 120 and the communication unit 14 (S204).

On the other hand, if the user is not a qualified person as a result of the authentication process (S203), a notice to the effect that the authentication has failed is sent to the image processing apparatus 10 (S205). In the image processing apparatus 10, the display control section 110 allows the display section 18 to show an authentication failure.

Although an exemplary example has been shown in which the authentication process is performed on the side of the server 12 in this embodiment, the authentication process may be performed on the side of the image processing apparatus 10.

FIG. 9 shows a result of the replying process of the detailed information at step S204. In FIG. 9, the contents of the reply include a message to the effect that the authentication has succeeded, and the address, name, telephone number, etc., of an individual whose detailed information has been required to be sent. The detailed information is not limited to that of FIG. 9, and may be, for example, the detailed content of a product.

The program that executes the steps of FIGS. 7 and 8 may be recorded on a recording medium, and may be provided by a communication unit. If so, for example, the program described above may be regarded as the invention of “a computer-readable recording medium on which a program is recorded.”

The “computer-readable recording medium on which a program is recorded” denotes a computer-readable recording medium on which a program is recorded and that is used to install, execute, or distribute the program.

Examples of the recording medium include a digital versatile disk (DVD), such as “DVD-R, DVD-RW, DVD-RAM, etc.” each of which has a standard established by the DVD Forum or “DVD+R, DVD+RW, etc.” each of which has a standard established by DVD+RW, a compact disk (CD), such as a CD read-only memory (CD-ROM), a CD recordable (CD-R), or a CD rewritable (CD-RW), a magneto-optical disk (MO), a flexible disk (FD), a magnetic tape, a hard disk, a read-only memory (ROM), an electrically erasable programmable read-only memory (EEPROM), a flash memory, and a random access memory (RAM).

The program or a part of the program may be preserved or distributed by being recorded on the recording medium. The program may be transmitted through a communication network, such as a local area network (LAN), a metropolitan area network (MAN), a wide area network (WAN), or a wired network or a radio communication network used in the Internet, intranet, or extranet, or through transmission media formed by combining these networks. The program may also be carried while being placed on a carrier wave.

The program may be a part of another program, or may be recorded on a recording medium together with different programs. Further, the program may be divided into program parts so as to be recorded on a plurality of recording mediums, respectively.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An image processing apparatus comprising:
an image reading unit that reads an information image on which a plurality of sets each of which comprises image information and additional information related to the image information are displayed according to a predetermined rule;
an image information acquiring unit that acquires the image information from the information image read by the image reading unit;
an additional information acquiring unit that acquires the additional information from the information image read by the image reading unit;
a positional relationship acquiring unit that acquires a positional relationship between the image information and the additional information;
a first partition setting unit that sets at least one first partition on the information image so as to divide a line of the plurality of sets in a first direction of the information image with respect to a display of the information image, based on the positional relationship acquired by the positional relationship acquiring unit;
a second partition setting unit that sets at least one second partition on the information image so as to divide a line of the plurality of sets in a second direction of the information image with respect to a display of the information image, based on the positional relationship acquired by the positional relationship acquiring unit, wherein the first direction and the second direction are set to intersect with each other, and the at least one first partition and the at least one second partition are set so that all the plurality of sets are individually placed in each area identified by the at least one first partition and the at least one second partition; and
a display control unit that displays an input screen that accepts instruction information for each area identified by the at least one first partition and the at least one second partition.

2. An image processing apparatus comprising:
an image reading unit that reads an information image on which a plurality of sets each of which comprises image information and additional information related to the image information are displayed according to a predetermined rule;
an image information acquiring unit that acquires the image information from the information image read by the image reading unit;
an additional information acquiring unit that acquires the additional information from the information image read by the image reading unit;
a positional relationship acquiring unit that acquires a positional relationship between the image information and the additional information;
a vertical partition setting unit that sets at least one vertical partition on the information image so as to divide a line of the plurality of sets in a rightward and leftward direction of the information image with respect to a display of the information image, based on the positional relationship acquired by the positional relationship acquiring unit;
a horizontal partition setting unit that sets at least one horizontal partition on the information image so as to divide a line of the plurality of sets in an upward and downward direction of the information image with respect to a display of the information image, based on the positional relationship acquired by the positional relationship acquiring unit, wherein the at least one vertical partition and the at least one horizontal partition are set so that all the plurality of sets are individually placed in each area identified by the at least one vertical partition and the at least one horizontal partition; and
a display control unit that displays an input screen that accepts instruction information for each area identified by the at least one vertical partition and the at least one horizontal partition.

3. The image processing apparatus according to claim 1,
wherein the additional information is storage location information that shows a storage location of detailed information related to the image information, and
the instruction information is an instruction to acquire the detailed information from the storage location.

4. The image processing apparatus according to claim 1,
wherein the first partition setting unit detects a distance between both ends in the first direction of the information image, and sets a position of the at least one first partition by dividing the distance therebetween by the number of the plurality of sets in the first direction, and
the second partition setting unit detects a distance between both ends in the second direction of the information image, and sets a position of the at least one second partition by dividing the distance therebetween by the number of the plurality of sets in the second direction.

5. The image processing apparatus according to claim 2,
wherein the vertical partition setting unit detects a distance between both ends in the rightward and leftward direction of the information image, and sets a position of the at least one vertical partition by dividing the distance therebetween by the number of the plurality of sets in the rightward and leftward direction, and
the horizontal partition setting unit detects a distance between both ends in the upward and downward direction of the information image, and sets a position of the at least one horizontal partition by dividing the distance therebetween by the number of the plurality of sets in the upward and downward direction.

6. The image processing apparatus according to claim 1,
wherein the positional relationship between the image information and the additional information shows a position of the additional information in an upward and downward direction or in a rightward and leftward direction with respect to the image information.

7. An information management system comprising:
the image processing apparatus according to claim 3;
a detailed information storage unit that stores the detailed information as the storage location; and
a detailed information requiring unit that requires the detailed information storage unit to send the detailed information, based on the instruction information.

8. The information management system according to claim 7, further comprising:
an authentication unit that performs a predetermined authentication process when the detailed information requiring unit requires the detailed information storage unit to send the detailed information.

9. A computer readable medium storing a program causing a computer to execute a process for processing an image, the process comprising:
reading an information image on which a plurality of sets each of which comprises image information and additional information related to the image information are displayed according to a predetermined rule;
acquiring the image information from the information image;
acquiring the additional information from the information image;
acquiring a positional relationship between the image information and the additional information;
setting at least one first partition on the information image so as to divide a line of the plurality of sets in a first direction of the information image with respect to a display of the information image, based on the positional relationship;
setting at least one second partition on the information image so as to divide a line of the plurality of sets in a second direction of the information image with respect to a display of the information image, based on the positional relationship, wherein the first direction and the second direction are set to intersect with each other, and the at least one first partition and the at least one second partition are set so that all the plurality of sets are individually placed in each area identified by the at least one first partition and the at least one second partition; and
displaying an input screen that accepts instruction information for each area identified by the at least one first partition and the at least one second partition.

10. A computer readable medium storing a program causing a computer to execute a process for processing an image, the process comprising:
reading an information image on which a plurality of sets each of which comprises image information and additional information related to the image information are displayed according to a predetermined rule;
acquiring the image information from the information image;
acquiring the additional information from the information image;
acquiring a positional relationship between the image information and the additional information;
setting at least one vertical partition on the information image so as to divide a line of the plurality of sets in a rightward and leftward direction of the information image with respect to a display of the information image, based on the positional relationship;
setting at least one horizontal partition on the information image so as to divide a line of the plurality of sets in an upward and downward direction of the information image with respect to a display of the information image, based on the positional relationship, wherein the at least one vertical partition and the at least one horizontal partition are set so that all the plurality of sets are individually placed in each area identified by the at least one vertical partition and the at least one horizontal partition; and
displaying an input screen that accepts instruction information for each area identified by the at least one vertical partition and the at least one horizontal partition.

11. A computer data signal embodied in a carrier wave for enabling a computer to perform a process for processing an image, the process comprising:
reading an information image on which a plurality of sets each of which comprises image information and additional information related to the image information are displayed according to a predetermined rule;
acquiring the image information from the information image;
acquiring the additional information from the information image;
acquiring a positional relationship between the image information and the additional information;
setting at least one first partition on the information image so as to divide a line of the plurality of sets in a first direction of the information image with respect to a display of the information image, based on the positional relationship;
setting at least one second partition on the information image so as to divide a line of the plurality of sets in a second direction of the information image with respect to a display of the information image, based on the positional relationship, wherein the first direction and the second direction are set to intersect with each other, and the at least one first partition and the at least one second partition are set so that all the plurality of sets are individually placed in each area identified by the at least one first partition and the at least one second partition; and
displaying an input screen that accepts instruction information for each area identified by the at least one first partition and the at least one second partition.

12. A computer data signal embodied in a carrier wave for enabling a computer to perform a process for processing an image, the process comprising:
reading an information image on which a plurality of sets each of which comprises image information and additional information related to the image information are displayed according to a predetermined rule;
acquiring the image information from the information image;
acquiring the additional information from the information image;
acquiring a positional relationship between the image information and the additional information;
setting at least one vertical partition on the information image so as to divide a line of the plurality of sets in a rightward and leftward direction of the information image with respect to a display of the information image, based on the positional relationship;
setting at least one horizontal partition on the information image so as to divide a line of the plurality of sets in an upward and downward direction of the information image with respect to a display of the information image, based on the positional relationship, wherein the at least one vertical partition and the at least one horizontal partition are set so that all the plurality of sets are individually placed in each area identified by the at least one vertical partition and the at least one horizontal partition; and
displaying an input screen that accepts instruction information for each area identified by the at least one vertical partition and the at least one horizontal partition.

13. A process for processing an image, the process comprising:
reading an information image on which a plurality of sets each of which comprises image information and additional information related to the image information are displayed according to a predetermined rule;
acquiring the image information from the information image;
acquiring the additional information from the information image;
acquiring a positional relationship between the image information and the additional information;
setting at least one first partition on the information image so as to divide a line of the plurality of sets in a first direction of the information image with respect to a display of the information image, based on the positional relationship;
setting at least one second partition on the information image so as to divide a line of the plurality of sets in a second direction of the information image with respect to a display of the information image, based on the positional relationship, wherein the first direction and the second direction are set to intersect with each other, and the at least one first partition and the at least one second partition are set so that all the plurality of sets are individually placed in each area identified by the at least one first partition and the at least one second partition; and
displaying an input screen that accepts instruction information for each area identified by the at least one first partition and the at least one second partition.

14. A process for processing an image, the process comprising:
reading an information image on which a plurality of sets each of which comprises image information and additional information related to the image information are displayed according to a predetermined rule;
acquiring the image information from the information image;
acquiring the additional information from the information image;
acquiring a positional relationship between the image information and the additional information;
setting at least one vertical partition on the information image so as to divide a line of the plurality of sets in a rightward and leftward direction of the information image with respect to a display of the information image, based on the positional relationship;
setting at least one horizontal partition on the information image so as to divide a line of the plurality of sets in an upward and downward direction of the information image with respect to a display of the information image, based on the positional relationship, wherein the at least one vertical partition and the at least one horizontal partition are set so that all the plurality of sets are individually placed in each area identified by the at least one vertical partition and the at least one horizontal partition; and
displaying an input screen that accepts instruction information for each area identified by the at least one vertical partition and the at least one horizontal partition.
